(19) United States
(12) Patent Application Publication
(10) Pub. No.: US 2026/0259401 A1
(43) Pub. Date: Sep. 3, 2026

(54) Tunable Lens with Actuator Brakes

(71) Applicant: Apple Inc., Cupertino, CA (US)

(72) Inventors: Oliver Hart, Cambridge (GB); Daniel J Burbridge, Cambridge (GB); Thomas M Gregory, Cambridgeshire (GB); Ross Cunningham, Cambridge (GB); Richard J Topliss, Cambridge (GB)

(21) Appl. No.: 19/444,631

(22) Filed: Jan. 9, 2026

Related U.S. Application Data
(60) Provisional application No. 63/764,822, filed on Feb. 28, 2025.

(51) Int. Cl. G02B 26/00; F03G 7/06; F16D 55/225; F16D 65/00; F16D 65/095; F16D 65/18; H02N 10/00; F16D 121/14; F16D 121/20; F16D 121/34; F16D 125/66

(52) U.S. Cl. CPC G02B 26/004; F03G 7/06143; F03G 7/064; F16D 55/225; F16D 65/0068; F16D 65/095; F16D 65/18; H02N 10/00; F16D 2121/14; F16D 2121/20; F16D 2121/34; F16D 2125/66

(57) ABSTRACT

An electronic device may include a lens module with a tunable lens. The tunable lens may include a flexible lens element and a lens shaping structure attached to the flexible lens element. The lens shaping structure may include tabs that are each coupled to a respective actuator. The actuator may move the tab up and down along an axis of displacement. The actuator may have a structure that is configured to rotate about a pivot axis. When it is not desired to adjust the tunable lens, a brake assembly in the actuator may apply a force to the structure in a direction parallel to the pivot axis. The brake assembly may include one or more brake calipers with wedge-shaped surfaces, brake cams, L-shaped brake structures, flexures, and/or piezoelectric members to apply the force to the structure.

### CROSS-REFERENCE TO RELATED APPLICATIONS

This application claims the benefit of U.S. provisional patent application No. 63/764,822, filed February 28, 2025, which is hereby incorporated by reference herein in its entirety.

### BACKGROUND

This relates generally to electronic devices and, more particularly, to wearable electronic device systems.

Electronic devices are sometimes configured to be worn by users. For example, head-mounted devices are provided with head-mounted structures that allow the devices to be worn on users’ heads. The head-mounted devices may include optical systems with lenses.

Head-mounted devices typically include lenses with fixed shapes and properties. If care is not taken, it may be difficult to adjust these types of lenses to optimally present content to each user of the head-mounted device.

### SUMMARY

An actuator may include a main structure, an actuating component that is coupled to the main structure and is configured to selectively rotate the main structure about a pivot axis, and a brake assembly that is configured to selectively fix a position of the main structure. The brake assembly may include a brake that is configured to apply a force to the main structure in a direction parallel to the pivot axis.

An actuator may include a housing comprising first and second wedges, a main structure in the housing, the main structure including opposing first and second surfaces, an actuating component in the housing that is configured to selectively rotate the main structure about a pivot axis, and a brake assembly in the housing that is configured to selectively fix a position of the main structure. The brake assembly may include a first brake caliper that is configured to move along the first wedge of the housing to apply a first force to the first surface of the main structure in a first direction parallel to the pivot axis, a second brake caliper that is configured to move along the second wedge of the housing to apply a second force to the second surface of the main structure in a second direction parallel to the pivot axis, a spring that is configured to bias the first and second brake calipers toward the main structure to maintain the first and second forces on the main structure, and a spring actuation component configured to selectively engage the spring to move the first and second brake calipers along the first and second wedges and away from the main structure.

An actuator may include a housing, a structure in the housing, the structure including opposing first and second surfaces, an actuating component in the housing is configured to selectively rotate the structure about a pivot axis, and a brake assembly in the housing that is configured to selectively fix a position of the structure. The brake assembly includes a first brake pad that is configured to apply a first force to the first surface of the structure in a first direction parallel to the pivot axis, a second brake pad that is configured to apply a second force to the second surface of the structure in a second direction parallel to the pivot axis, a flexure to which the first and second brake pads are coupled, and a flexure actuation component that is configured to move at least a portion of the flexure to move the first and second brake pads away from the structure.

### BRIEF DESCRIPTION OF THE DRAWINGS

FIG. 1 is a schematic diagram of an illustrative electronic device in accordance with some embodiments.

FIG. 2 is a top view of an illustrative head-mounted device with a lens module in accordance with some embodiments.

FIG. 3 is a side view of an illustrative lens module in accordance with some embodiments.

FIGS. 4 and 5 are side views of an illustrative tunable lens in different tuning states in accordance with some embodiments.

FIG. 6 is a top view of an illustrative tunable lens with a lens shaping structure in accordance with some embodiments.

FIG. 7 is a side view of an illustrative actuator having a brake assembly with wedge-shaped brake calipers in accordance with some embodiments.

FIG. 8 is a side view of an illustrative actuator having a brake assembly with wedge-shaped brake calipers joined with a pivoting component in accordance with some embodiments.

FIG. 9 is a side view of an illustrative actuator having a brake assembly with a single wedge-shaped brake caliper in accordance with some embodiments.

FIG. 10A is a side view of an illustrative actuator having a brake assembly with brake cams in accordance with some embodiments.

FIG. 10B is a side view of an illustrative actuator having a brake assembly with a single brake cam in accordance with some embodiments.

FIG. 10C is a side view of an illustrative actuator having a brake assembly with an L-shaped brake structure in accordance with some embodiments.

FIG. 11 is a side view of an illustrative actuator having a brake assembly with wedge-shaped brake calipers that engage wedges in a pivoting structure in accordance with some embodiments.

FIGS. 12A-12D are side views of illustrative actuators having brake assemblies with flexures coupled to brake pads in accordance with some embodiments.

FIGS. 13A and 13B are side views of illustrative actuators having brake assemblies with bistable flexures coupled to brake pads in accordance with some embodiments.

FIG. 14 is a side view of an illustrative actuator having a brake assembly that includes flexure springs and piezoelectric members in accordance with some embodiments.

### DETAILED DESCRIPTION

An electronic device, such as a head-mounted device, may include a tunable lens. The tunable lens may have adjustable optical properties. For example, actuators may move a periphery of the tunable lens to adjust the optical properties. In some embodiments, the actuators may include structures that are coupled to the tunable lens and that rotate about pivot axes.

When the tunable lens is not being adjusted, it may be desirable to fix the location of the actuators and therefore the periphery of the tunable lens to avoid adjustments to the tunable lens. Therefore, the actuators may include brake assemblies that include brakes, such as brake calipers, to prevent rotation of the structures. The brakes may apply a force to the structures in directions parallel to the pivot axes. In this way, the brake assemblies may prevent the rotation of the structures, and therefore the adjustment of the tunable lens, without applying undue stress to the structures.

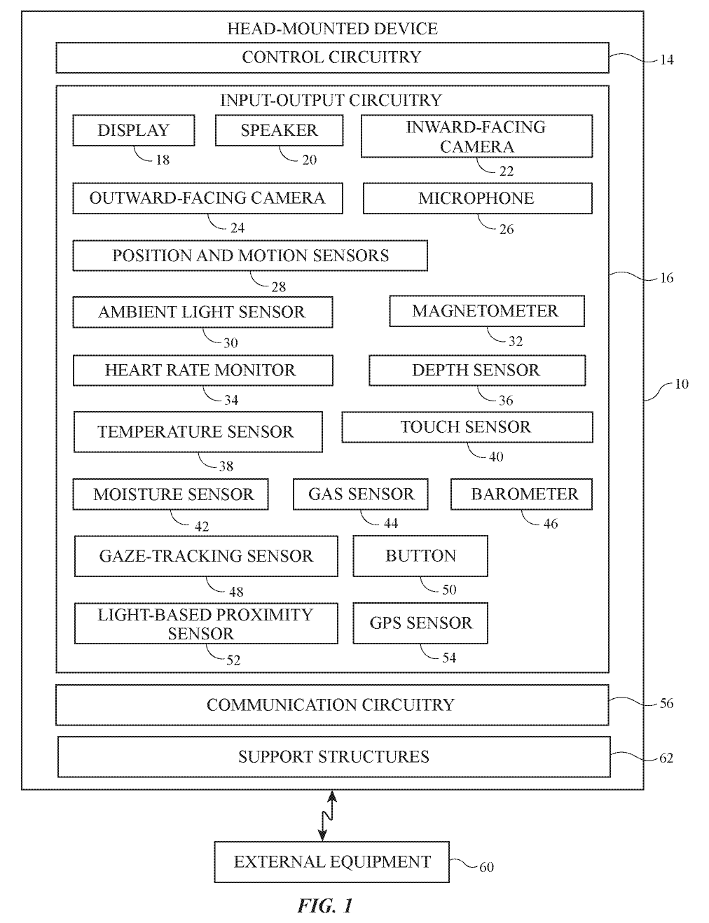

A schematic diagram of an illustrative electronic device that may include tunable lenses is shown in FIG. 1. As shown in FIG. 1, electronic device 10 (sometimes referred to as head-mounted device 10, system 10, head-mounted display 10, etc.) may have control circuitry 14. In addition to being a head-mounted device, electronic device 10 may be other types of electronic devices such as a cellular telephone, laptop computer, speaker, computer monitor, electronic watch, tablet computer, etc. Control circuitry 14 may be configured to perform operations in head-mounted device 10 using hardware (e.g., dedicated hardware or circuitry), firmware and/or software. Software code for performing operations in head-mounted device 10 and other data is stored on non-transitory computer readable storage media (e.g., tangible computer readable storage media) in control circuitry 14. The software code may sometimes be referred to as software, data, program instructions, instructions, or code. The non-transitory computer readable storage media (sometimes referred to generally as memory) may include non-volatile memory such as non-volatile random-access memory (NVRAM), one or more hard drives (e.g., magnetic drives or solid-state drives), one or more removable flash drives or other removable media, or the like. Software stored on the non-transitory computer readable storage media may be executed on the processing circuitry of control circuitry 14. The processing circuitry may include application-specific integrated circuits with processing circuitry, one or more microprocessors, digital signal processors, graphics processing units, a central processing unit (CPU) or other processing circuitry.

Head-mounted device 10 may include input-output circuitry 16. Input-output circuitry 16 may be used to allow a user to provide head-mounted device 10 with user input. Input-output circuitry 16 may also be used to gather information on the environment in which head-mounted device 10 is operating. Output components in circuitry 16 may allow head-mounted device 10 to provide a user with output.

As shown in FIG. 1, input-output circuitry 16 may include a display such as display 18. Display 18 may be used to display images for a user of head-mounted device 10. Display 18 may be a transparent or translucent display so that a user may observe physical objects through the display while computer-generated content is overlaid on top of the physical objects by presenting computer-generated images on the display. A transparent or translucent display may be formed from a transparent or translucent pixel array (e.g., a transparent organic light-emitting diode display panel) or may be formed by a display device that provides images to a user through a transparent structure such as a beam splitter, holographic coupler, or other optical coupler (e.g., a display device such as a liquid crystal on silicon display). Alternatively, display 18 may be an opaque display that blocks light from physical objects when a user operates head-mounted device 10. In this type of arrangement, a pass-through camera may be used to display physical objects to the user. The pass-through camera may capture images of the physical environment and the physical environment images may be displayed on the display for viewing by the user. Additional computer-generated content (e.g., text, game-content, other visual content, etc.) may optionally be overlaid over the physical environment images to provide an extended reality environment for the user. When display 18 is opaque, the display may also optionally display entirely computer-generated content (e.g., without displaying images of the physical environment).

Display 18 may include one or more optical systems (e.g., lenses) (sometimes referred to as optical assemblies) that allow a viewer to view images on display(s) 18. A single display 18 may produce images for both eyes, or a pair of displays 18 may be used to display images. In configurations with multiple displays (e.g., left and right eye displays), the focal length and positions of the lenses may be selected so that any gap present between the displays will not be visible to a user (e.g., so that the images of the left and right displays overlap or merge seamlessly). Display modules (sometimes referred to as display assemblies) that generate different images for the left and right eyes of the user may be referred to as stereoscopic displays. The stereoscopic displays may be capable of presenting two-dimensional content (e.g., a user notification with text) and three-dimensional content (e.g., a simulation of a physical object such as a cube).

The example of device 10 including a display is merely illustrative and display(s) 18 may be omitted from device 10 if desired. Device 10 may include an optical pass-through area where real-world content is viewable to the user either directly or through a tunable lens.

Input-output circuitry 16 may include various other input-output devices. For example, input-output circuitry 16 may include one or more speakers 20 that are configured to play audio and one or more microphones 26 that are configured to capture audio data from the user and/or from the physical environment around the user.

Input-output circuitry 16 may also include one or more cameras such as an inward-facing camera 22 (e.g., that face the user’s face when the head-mounted device is mounted on the user’s head) and an outward-facing camera 24 (that face the physical environment around the user when the head-mounted device is mounted on the user’s head). Cameras 22 and 24 may capture visible light images, infrared images, or images of any other desired type. The cameras may be stereo cameras if desired. Inward-facing camera 22 may capture images that are used for gaze-detection operations, in one possible arrangement. Outward-facing camera 24 may capture pass-through video for head-mounted device 10.

As shown in FIG. 1, input-output circuitry 16 may include position and motion sensors 28 (e.g., compasses, gyroscopes, accelerometers, and/or other devices for monitoring the location, orientation, and movement of head-mounted device 10, satellite navigation system circuitry such as Global Positioning System circuitry for monitoring user location, etc.). Using sensors 28, for example, control circuitry 14 can monitor the current direction in which a user’s head is oriented relative to the surrounding environment (e.g., a user’s head pose). One or more of cameras 22 and 24 may also be considered part of position and motion sensors 28. The cameras may be used for face tracking (e.g., by capturing images of the user’s jaw, mouth, etc. while the device is worn on the head of the user), body tracking (e.g., by capturing images of the user’s torso, arms, hands, legs, etc. while the device is worn on the head of user), and/or for localization (e.g., using visual odometry, visual inertial odometry, or other simultaneous localization and mapping (SLAM) technique).

Input-output circuitry 16 may also include other sensors and input-output components if desired. As shown in FIG. 1, input-output circuitry 16 may include an ambient light sensor 30. The ambient light sensor may be used to measure ambient light levels around head-mounted device 10. The ambient light sensor may measure light at one or more wavelengths (e.g., different colors of visible light and/or infrared light).

Input-output circuitry 16 may include a magnetometer 32. The magnetometer may be used to measure the strength and/or direction of magnetic fields around head-mounted device 10.

Input-output circuitry 16 may include a heart rate monitor 34. The heart rate monitor may be used to measure the heart rate of a user wearing head-mounted device 10 using any desired techniques.

Input-output circuitry 16 may include a depth sensor 36. The depth sensor may be a pixelated depth sensor (e.g., that is configured to measure multiple depths across the physical environment) or a point sensor (that is configured to measure a single depth in the physical environment). The depth sensor (whether a pixelated depth sensor or a point sensor) may use phase detection (e.g., phase detection autofocus pixel(s)) or light detection and ranging (LIDAR) to measure depth. Any combination of depth sensors may be used to determine the depth of physical objects in the physical environment.

Input-output circuitry 16 may include a temperature sensor 38. The temperature sensor may be used to measure the temperature of a user of head-mounted device 10, the temperature of head-mounted device 10 itself, or an ambient temperature of the physical environment around head-mounted device 10.

Input-output circuitry 16 may include a touch sensor 40. The touch sensor may be, for example, a capacitive touch sensor that is configured to detect touch from a user of the head-mounted device.

Input-output circuitry 16 may include a moisture sensor 42. The moisture sensor may be used to detect the presence of moisture (e.g., water) on, in, or around the head-mounted device.

Input-output circuitry 16 may include a gas sensor 44. The gas sensor may be used to detect the presence of one or more gases (e.g., smoke, carbon monoxide, etc.) in or around the head-mounted device.

Input-output circuitry 16 may include a barometer 46. The barometer may be used to measure atmospheric pressure, which may be used to determine the elevation above sea level of the head-mounted device.

Input-output circuitry 16 may include a gaze-tracking sensor 48 (sometimes referred to as gaze-tracker 48 and gaze-tracking system 48). The gaze-tracking sensor 48 may include a camera (e.g., inward-facing camera 22) and/or other gaze-tracking sensor components (e.g., light sources that emit beams of light so that reflections of the beams from a user’s eyes may be detected) to monitor the user’s eyes. Gaze-tracker 48 may face a user’s eyes and may track a user’s gaze. A camera in the gaze-tracking system may determine the location of a user’s eyes (e.g., the centers of the user’s pupils), may determine the direction in which the user’s eyes are oriented (the direction of the user’s gaze), may determine the user’s pupil size (e.g., so that light modulation and/or other optical parameters and/or the amount of gradualness with which one or more of these parameters is spatially adjusted and/or the area in which one or more of these optical parameters is adjusted is adjusted based on the pupil size), may be used in monitoring the current focus of the lenses in the user’s eyes (e.g., whether the user is focusing in the near field or far field, which may be used to assess whether a user is day dreaming or is thinking strategically or tactically), and/or other gaze information. Cameras in the gaze-tracking system may sometimes be referred to as inward-facing cameras, gaze-detection cameras, eye-tracking cameras, gaze-tracking cameras, or eye-monitoring cameras. If desired, other types of image sensors (e.g., infrared and/or visible light-emitting diodes and light detectors, etc.) may also be used in monitoring a user’s gaze. The use of a gaze-detection camera in gaze-tracker 48 is merely illustrative.

Input-output circuitry 16 may include a button 50. The button may include a mechanical switch that detects a user press during operation of the head-mounted device.

Input-output circuitry 16 may include a light-based proximity sensor 52. The light-based proximity sensor may include a light source (e.g., an infrared light source) and an image sensor (e.g., an infrared image sensor) configured to detect reflections of the emitted light to determine proximity to nearby objects.

Input-output circuitry 16 may include a global positioning system (GPS) sensor 54. The GPS sensor may determine location information for the head-mounted device. The GPS sensor may include one or more antennas used to receive GPS signals. The GPS sensor may be considered a part of position and motion sensors 28.

Input-output circuitry 16 may include any other desired components (e.g., capacitive proximity sensors, other proximity sensors, strain gauges, pressure sensors, audio components, haptic output devices such as vibration motors, light-emitting diodes, other light sources, etc.).

Head-mounted device 10 may also include communication circuitry 56 to allow the head-mounted device to communicate with external equipment (e.g., a tethered computer, a portable device such as a handheld device or laptop computer, one or more external servers, or other electrical equipment). Communication circuitry 56 may be used for both wired and wireless communication with external equipment.

Communication circuitry 56 may include radio-frequency (RF) transceiver circuitry formed from one or more integrated circuits, power amplifier circuitry, low-noise input amplifiers, passive RF components, one or more antennas, transmission lines, and other circuitry for handling RF wireless signals. Wireless signals can also be sent using light (e.g., using infrared communications).

The radio-frequency transceiver circuitry in wireless communications circuitry 56 may handle wireless local area network (WLAN) communications bands such as the 2.4 GHz and 5 GHz Wi-Fi® (IEEE 802.11) bands, wireless personal area network (WPAN) communications bands such as the 2.4 GHz Bluetooth® communications band, cellular telephone communications bands such as a cellular low band (LB) (e.g., 600 to 960 MHz), a cellular low-midband (LMB) (e.g., 1400 to 1550 MHz), a cellular midband (MB) (e.g., from 1700 to 2200 MHz), a cellular high band (HB) (e.g., from 2300 to 2700 MHz), a cellular ultra-high band (UHB) (e.g., from 3300 to 5000 MHz, or other cellular communications bands between about 600 MHz and about 5000 MHz (e.g., 3G bands, 4G LTE bands, 5G New Radio Frequency Range 1 (FR1) bands below 10 GHz, etc.), a near-field communications (NFC) band (e.g., at 13.56 MHz), satellite navigations bands (e.g., an L1 global positioning system (GPS) band at 1575 MHz, an L5 GPS band at 1176 MHz, a Global Navigation Satellite System (GLONASS) band, a BeiDou Navigation Satellite System (BDS) band, etc.), ultra-wideband (UWB) communications band(s) supported by the IEEE 802.15.4 protocol and/or other UWB communications protocols (e.g., a first UWB communications band at 6.5 GHz and/or a second UWB communications band at 8.0 GHz), and/or any other desired communications bands.

The radio-frequency transceiver circuitry may include millimeter/centimeter wave transceiver circuitry that supports communications at frequencies between about 10 GHz and 300 GHz. For example, the millimeter/centimeter wave transceiver circuitry may support communications in Extremely High Frequency (EHF) or millimeter wave communications bands between about 30 GHz and 300 GHz and/or in centimeter wave communications bands between about 10 GHz and 30 GHz (sometimes referred to as Super High Frequency (SHF) bands). As examples, the millimeter/centimeter wave transceiver circuitry may support communications in an IEEE K communications band between about 18 GHz and 27 GHz, a Kₐ communications band between about 26.5 GHz and 40 GHz, a Kᵤ communications band between about 12 GHz and 18 GHz, a V communications band between about 40 GHz and 75 GHz, a W communications band between about 75 GHz and 110 GHz, or any other desired frequency band between approximately 10 GHz and 300 GHz. If desired, the millimeter/centimeter wave transceiver circuitry may support IEEE 802.11ad communications at 60 GHz (e.g., WiGig or 60 GHz Wi-Fi bands around 57-61 GHz), and/or 5^{th} generation mobile networks or 5^{th} generation wireless systems (5G) New Radio (NR) Frequency Range 2 (FR2) communications bands between about 24 GHz and 90 GHz.

Antennas in wireless communications circuitry 56 may include antennas with resonating elements that are formed from loop antenna structures, patch antenna structures, inverted-F antenna structures, slot antenna structures, planar inverted-F antenna structures, helical antenna structures, dipole antenna structures, monopole antenna structures, hybrids of these designs, etc. Different types of antennas may be used for different bands and combinations of bands. For example, one type of antenna may be used in forming a local wireless link and another type of antenna may be used in forming a remote wireless link antenna.

During operation, head-mounted device 10 may use communication circuitry 56 to communicate with external equipment 60. External equipment 60 may include one or more external servers, an electronic device that is paired with head-mounted device 10 (such as a cellular telephone, a laptop computer, a speaker, a computer monitor, an electronic watch, a tablet computer, earbuds, etc.), a vehicle, an internet of things (IoT) device (e.g., remote control, light switch, doorbell, lock, smoke alarm, light, thermostat, oven, refrigerator, stove, grill, coffee maker, toaster, microwave, etc.), etc.

Electronic device 10 may have housing structures (e.g., housing walls, straps, etc.), as shown by illustrative support structures 62 of FIG. 1. In configurations in which electronic device 10 is a head-mounted device (e.g., a pair of glasses, goggles, a helmet, a hat, etc.), support structures 62 may include head-mounted support structures (e.g., a helmet housing, head straps, temples in a pair of eyeglasses, goggle housing structures, and/or other head-mounted structures). The head-mounted support structures may be configured to be worn on a head of a user during operation of device 10 and may support control circuitry 14, input-output circuitry 16, and/or communication circuitry 56.

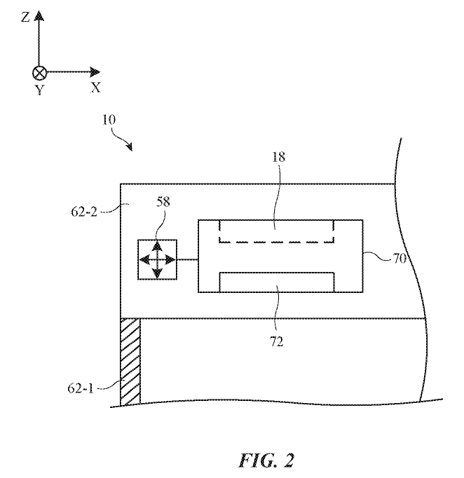

FIG. 2 is a top view of electronic device 10 in an illustrative configuration in which electronic device 10 is a head-mounted device. As shown in FIG. 2, electronic device 10 may include support structures (see, e.g., support structures 62 of FIG. 1) that are used in housing the components of device 10 and mounting device 10 onto a user’s head. These support structures may include, for example, structures that form housing walls and other structures for main unit 62-2 (e.g., exterior housing walls, lens module structures, etc.) and eyeglass temples or other supplemental support structures such as structures 62-1 that help to hold main unit 62-2 on a user’s face.

The electronic device may include optical modules such as optical module 70. The electronic device may include left and right optical modules that correspond respectively to a user’s left eye and right eye. An optical module corresponding to the user’s left eye is shown in FIG. 2.

Each optical module 70 includes a corresponding lens module 72 (sometimes referred to as lens stack-up 72, lens 72, or adjustable lens 72). Lens 72 may include one or more lens elements arranged along a common axis. Each lens element may have any desired shape and may be formed from any desired material (e.g., with any desired refractive index). The lens elements may have unique shapes and refractive indices that, in combination, focus light (e.g., from a display and/or from the physical environment) in a desired manner. Each lens element of lens module 72 may be formed from any desired material (e.g., glass, a polymer material such as polycarbonate or acrylic, a crystal such as sapphire, etc.).

Modules 70 may optionally be individually positioned relative to the user’s eyes and relative to some of the housing wall structures of main unit 26-2 using positioning circuitry such as positioner 58. Positioner 58 may include stepper motors, piezoelectric actuators, motors, linear electromagnetic actuators, shape memory alloys (SMAs), and/or other electronic components for adjusting the position of displays, the optical modules 70, and/or lens modules 72. Positioners 58 may be controlled by control circuitry 14 (FIG. 1) during operation of device 10. For example, positioners 58 may be used to adjust the spacing between modules 70 (and therefore the lens-to-lens spacing between the left and right lenses of modules 70) to match the interpupillary distance IPD of a user’s eyes. In another example, the lens module may include an adjustable lens element (also referred to as a tunable lens element herein). The curvature of the adjustable lens element may be adjusted in real time by positioner(s) 58 to compensate for a user’s eyesight and/or viewing conditions.

Each optical module may optionally include a display such as display 18 in FIG. 2. As previously mentioned, the displays may be omitted from device 10 if desired. In this type of arrangement, the device may still include one or more lens modules 72 (e.g., through which the user views the real world). In this type of arrangement, real-world content may be selectively focused for a user.

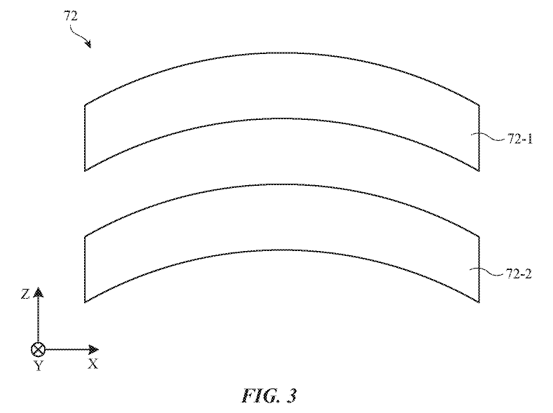

FIG. 3 is a cross-sectional side view of an illustrative lens module with multiple lens elements. As shown, lens module 72 includes a first lens element 72-1 and a second lens element 72-2. Each surface of the lens elements may have any desired curvature. For example, each surface may be a convex surface (e.g., a spherically convex surface, a cylindrically convex surface, or an aspherically convex surface), a concave surface (e.g., a spherically concave surface, a cylindrically concave surface, or an aspherically concave surface), a combination of convex and concave surfaces, or a freeform surface. A spherically curved surface (e.g., a spherically convex or spherically concave surface) may have a constant radius of curvature across the surface. In contrast, an aspherically curved surface (e.g., an aspheric concave surface or an aspheric convex surface) may have a varying radius of curvature across the surface. A cylindrical surface may only be curved about one axis instead of about multiple axes as with the spherical surface. In some cases, one of the lens surfaces may have an aspheric surface that changes from being convex (e.g., at the center) to concave (e.g., at the edges) at different positions on the surface. This type of surface may be referred to as an aspheric surface, a primarily convex (e.g., the majority of the surface is convex and/or the surface is convex at its center) aspheric surface, a freeform surface, and/or a primarily convex (e.g., the majority of the surface is convex and/or the surface is convex at its center) freeform surface. A freeform surface may include both convex and concave portions and/or curvatures defined by polynomial series and expansions. Alternatively, a freeform surface may have varying convex curvatures or varying concave curvatures (e.g., different portions with different radii of curvature, portions with curvature in one direction and different portions with curvature in two directions, etc.). Herein, a freeform surface that is primarily convex (e.g., the majority of the surface is convex and/or the surface is convex at its center) may sometimes still be referred to as a convex surface and a freeform surface that is primarily concave (e.g., the majority of the surface is concave and/or the surface is concave at its center) may sometimes still be referred to as a concave surface. In one example, shown in FIG. 3, lens element 72-1 has a convex surface that faces display 18 and an opposing concave surface. Lens element 72-2 has a convex surface that faces lens element 72-1 and an opposing concave surface.

One or both of lens elements 72-1 and 72-2 may be adjustable (also referred to as tunable herein). In one example, lens element 72-1 is a non-adjustable lens element whereas lens element 72-2 is an adjustable lens element. The adjustable lens element 72-2 may be used to accommodate a user’s eyeglass prescription, for example. The shape of lens element 72-2 may be adjusted if a user’s eyeglass prescription changes (without needing to replace any of the other components within device 10). As another possible use case, a first user with a first eyeglass prescription (or no eyeglass prescription) may use device 10 with lens element 72-2 having a first shape and a second, different user with a second eyeglass prescription may use device 10 with lens element 72-2 having a second shape that is different than the first shape. Lens element 72-2 may have varying lens power and/or may provide varying amounts and orientations of astigmatism correction to provide prescription correction for the user.

The example of lens module 72 including two lens elements is merely illustrative. In general, lens module 72 may include any desired number of lens elements (e.g., one, two, three, four, more than four, etc.). Any subset or all of the lens elements may optionally be adjustable. Any of the adjustable lens elements in the lens module may optionally be fluid-filled adjustable lenses. Lens module 72 may also include any desired additional optical layers (e.g., partially reflective mirrors that reflect 50% of incident light, linear polarizers, retarders such as quarter wave plates, reflective polarizers, circular polarizers, reflective circular polarizers, etc.) to manipulate light that passes through lens module.

In one possible arrangement, lens element 72-1 may be a removable lens element. In other words, a user may be able to easily remove and replace lens element 72-1 within optical module 70. This may allow lens element 72-1 to be customizable. If lens element 72-1 is permanently affixed to the lens assembly, the lens power provided by lens element 72-1 cannot be easily changed. However, by making lens element 72-1 customizable, a user may select a lens element 72-1 that best suits their eyes and place the appropriate lens element 72-1 in the lens assembly. The lens element 72-1 may be used to accommodate a user’s eyeglass prescription, for example. A user may replace lens element 72-1 with an updated lens element if their eyeglass prescription changes (without needing to replace any of the other components within electronic device 10). Lens element 72-1 may have varying lens power and/or may provide varying amount of astigmatism correction to provide prescription correction for the user. Lens element 72-1 may include one or more attachment structures that are configured to attach to corresponding attachment structures included in optical module 70, lens element 72-2, support structures 62, or another structure in electronic device 10.

In contrast with lens element 72-1, lens element 72-2 may not be a removable lens element. Lens element 72-2 may therefore sometimes be referred to as a permanent lens element, non-removable lens element, etc. The example of lens element 72-2 being a non-removable lens element is merely illustrative. In another possible arrangement, lens element 72-2 may also be a removable lens element (similar to lens element 72-1).

As previously mentioned, one or more of the adjustable lens elements may be a fluid-filled lens element. An example is described herein where lens element 72-2 from FIG. 3 is a fluid-filled lens element. When lens element 72-2 is a fluid-filled lens element, the lens element may include one or more components that define the surfaces of lens element 72-2. These components may also be referred to as lens elements. In other words, adjustable lens element 72-2 (sometimes referred to as adjustable lens module 72-2, adjustable lens 72-2, tunable lens 72-2, etc.) may be formed by multiple respective lens elements.

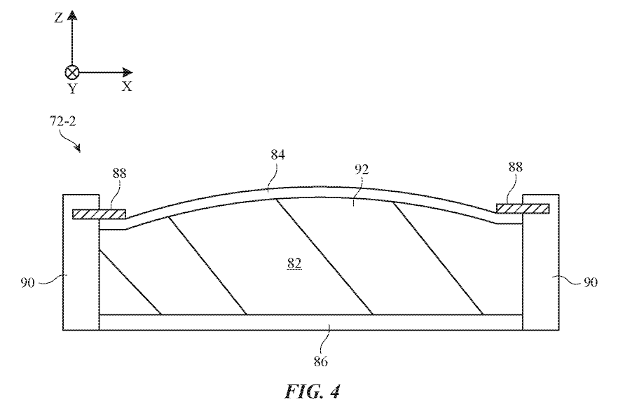

FIG. 4 is a cross-sectional side view of illustrative adjustable fluid-filled lens element 72-2. As shown, fluid-filled chamber 82 (sometimes referred to as chamber 82, fluid chamber 82, primary chamber 82, etc.) that includes fluid 92 is interposed between lens elements 84 and 86. Lens elements 84 and 86 may sometimes be referred to as part of chamber 82 or may sometimes be referred to as separate from chamber 82. Fluid 92 may be a liquid, gel, or gas with a pre-determined index of refraction (and may therefore sometimes be referred to as liquid 92, gel 92, or gas 92). The fluid may sometimes be referred to as an index-matching oil, an optical oil, an optical fluid, an index-matching material, an index-matching liquid, etc. Lens elements 84 and 86 may have the same index of refraction or may have different indices of refraction. Fluid 92 that fills chamber 82 between lens elements 84 and 86 may have an index of refraction that is the same as the index of refraction of lens element 84 but different from the index of refraction of lens element 86, may have an index of refraction that is the same as the index of refraction of lens element 86 but different from the index of refraction of lens element 84, may have an index of refraction that is the same as the index of refraction of lens element 84 and lens element 86, or may have an index of refraction that is different from the index of refraction of lens element 84 and lens element 86. Lens elements 84 and 86 may have a circular footprint, may have an elliptical footprint, or may have a footprint any another desired shape (e.g., an irregular footprint).

The amount of fluid 92 in chamber 82 may have a constant volume or an adjustable volume. If the amount of fluid is adjustable, the lens module may also include a fluid reservoir and a fluid controlling component (e.g., a pump, stepper motor, piezoelectric actuator, shape memory alloy (SMA), motor, linear electromagnetic actuator, and/or other electronic component that applies a force to the fluid in the fluid reservoir) for selectively transferring fluid between the fluid reservoir and the chamber.

Lens elements 84 and 86 may be transparent lens elements formed from any desired material (e.g., glass, a polymer material such as polycarbonate or acrylic, a crystal such as sapphire, etc.). Each one of lens elements 84 and 86 may be elastomeric, semi-rigid, or rigid. In one example, lens element 84 is an elastomeric lens element whereas lens element 86 is a rigid lens element.

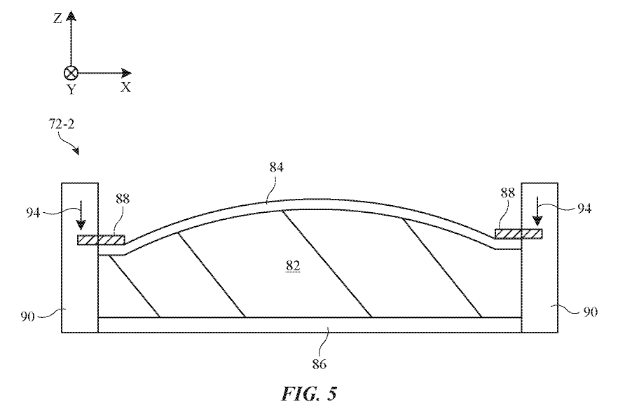

Elastomeric lens elements (e.g., lens element 84 in FIGS. 4 and 5) may be formed from a natural or synthetic polymer that has a low Young’s modulus for high flexibility. For example the elastomeric membrane may be formed from a material having a Young’s modulus of less than 1 GPa, less than 0.5 GPa, less than 0.1 GPa, etc.

Semi-rigid lens elements may be formed from a semi-rigid material that is stiff and solid, but not inflexible. A semi-rigid lens element may, for example, be formed from a thin layer of polymer or glass. Semi-rigid lens elements may be formed from a material having a Young’s modulus that is greater than 1 Gpa, greater than 2 GPa, greater than 3 GPa, greater than 10 GPa, greater than 25 GPa, etc. Semi-rigid lens elements may be formed from polycarbonate, polyethylene terephthalate (PET), polymethylmethacrylate (PMMA), acrylic, glass, or any other desired material. The properties of semi-rigid lens elements may result in the lens element becoming rigid along a first axis when the lens element is curved along a second axis perpendicular to the first axis or, more generally, for the product of the curvature along its two principal axes of curvature to remain roughly constant as it flexes. This is in contrast to an elastomeric lens element, which remains flexible along a first axis even when the lens element is curved along a second axis perpendicular to the first axis. The properties of semi-rigid lens elements may allow the semi-rigid lens elements to form a cylindrical lens with tunable lens power and a tunable axis.

Rigid lens elements (e.g., lens element 86 in FIGS. 4 and 5) may be formed from glass, a polymer material such as polycarbonate or acrylic, a crystal such as sapphire, etc. In general, the rigid lens elements may not deform when pressure is applied to the lens elements within the lens module. In other words, the shape and position of the rigid lens elements may be fixed. Each surface of a rigid lens element may be planar, concave (e.g., spherically, aspherically, or cylindrically concave), or convex (e.g., spherically, aspherically, or cylindrically convex). Rigid lens elements may be formed from a material having a Young’s modulus that is greater than greater than 25 GPa, greater than 30 GPa, greater than 40 GPa, greater than 50 GPa, etc.

In addition to lens elements 84 and 86 and fluid-filled chamber 82, lens module 72-2 also includes a lens shaping element 88. Lens shaping element 88 may be coupled to one or more actuators 90 (e.g., positioned around the circumference of the lens module). The lens shaping element 88 may also be coupled to lens element 84. Actuators 90 may be adjusted to adjust the position of lens shaping element 88 (sometimes referred to as lens shaper 88, deformable lens shaper 88, lens shaping structure 88, lens shaping member 88, annular member 88, ring-shaped structure 88, etc.). The lens shaping element 88 in turn manipulates the positioning/shape of lens element 84. In this way, the curvature of the lens element 84 (and accordingly, the lens power and/or other optical properties of lens module 72-2) may be adjusted. An example of actuators 90 and lens shaper 88 being used to change the curvature of lens element 84 in FIG. 5. As shown, lens shaper 88 is moved in direction 94 by actuators 90. This results in lens element 84 having more curvature in FIGS. 5 than in 4.

The example of tunable lens element 72-2 being a fluid-filled lens element is merely illustrative. In general, tunable lens element 72-2 may be any desired type of tunable lens element with adjustable optical power.

The shape (and corresponding optical power) of tunable lens element 72-2 may be adjusted in response to information from any of the components in input-output circuitry 16 (FIG. 1).

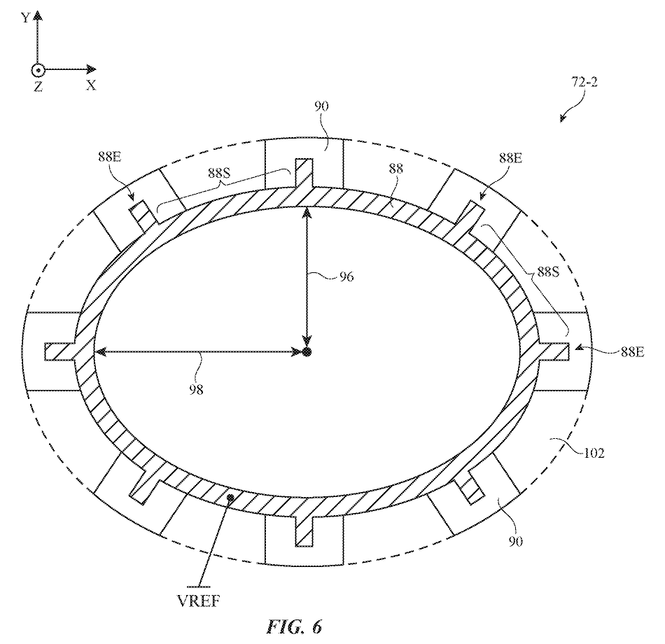

FIG. 6 is a top view of an illustrative lens shaping element 88. As shown, lens shaping element 88 may have an annular or ring shape with the lens shaping element surrounding a central opening. The lens shaping element may have any desired shape. For example, the lens shaping element may be circular, elliptical, or have an irregular shape. In the example of FIG. 6, the lens shaping element has an elliptical shape (e.g., a non-uniform radius around the ring shape). For example, a first distance 96 (e.g., a minimum distance) from the center of the central opening to the edge of the lens shaping element may be smaller than a second distance 98 (e.g., a maximum distance) from the center of the central opening to the edge of the lens shaping element. Distance 96 and 98 may be less than 100 millimeters, less than 60 millimeters, less than 40 millimeters, less than 30 millimeters, greater than 10 millimeters, greater than 20 millimeters, between 10 and 50 millimeters, etc.

Lens shaping element 88 has a plurality of tabs 88E that extend from the main portion of the lens shaping element. The tabs 88E (sometimes referred to as extensions 88E, actuator points 88E, etc.) may each be coupled to a respective actuator 90. Each actuator may selectively move its respective extension 88E up and down (e.g., in the Z-direction) to control the position of tab 88E in the Z-direction.

FIG. 6 shows how a plurality of tabs 88E (and corresponding actuators) may be distributed around the perimeter of lens shaping element 88. Tabs 88E may be distributed around lens shaping element 88 in a uniform manner (e.g., with equal spacing between each pair of adjacent tabs 88E) or in a non-uniform manner (e.g., with unequal spacing between at least two of the adjacent tabs 88E).

Between each pair of adjacent tabs 88E, there is a lens shaper segment 88S. In the example of FIG. 6, there are 8 tabs 88E and 8 actuators 90 around the perimeter of lens shaping element 88. This example is merely illustrative. In general, more tabs (and corresponding actuators) may allow for greater control of the shape of the lens element (e.g., lens element 84) to which lens shaping element 88 is coupled. Any desired number of tabs and actuators (e.g., one, two, three, four, more than four, more than six, more than eight, more than ten, more than twelve, more than twenty, less than twenty, less than ten, between four and twelve, etc.) may be used depending upon the specific target shapes for the lens element, the target cost/complexity of the lens module, etc.

Lens shaping element 88 may be elastomeric (e.g., a natural or synthetic polymer that has a low Young’s modulus for high flexibility, as discussed above in greater detail) or semi-rigid (e.g., formed from a semi-rigid material that is stiff and solid, but not inflexible, as discussed above in greater detail). A semi-rigid lens shaping element may, for example, be formed from a thin layer of polymer, glass, metal, etc. Because lens shaping element 88 is formed in a ring around the lens module, lens shaping element 88 does not need to be transparent (and therefore may be formed from an opaque material such as metal). The rigidity of lens shaping element 88 may be selected such that the lens shaping element assumes desired target shapes when manipulated by the actuators around its perimeter.

One or more structures such as a lens housing 102 (sometimes referred to as housing 102, lens chassis 102, chassis 102, support structure 102, bezel 102, ring-shaped housing 102, ring-shaped chassis 102, etc.) may also be included in tunable lens element 72-2. Actuators 90 may be positioned within lens housing 102. Lens housing 102 may optionally define a portion of the fluid-filled chamber 82. Lens housing 102 may extend in a ring around the periphery of the tunable lens.

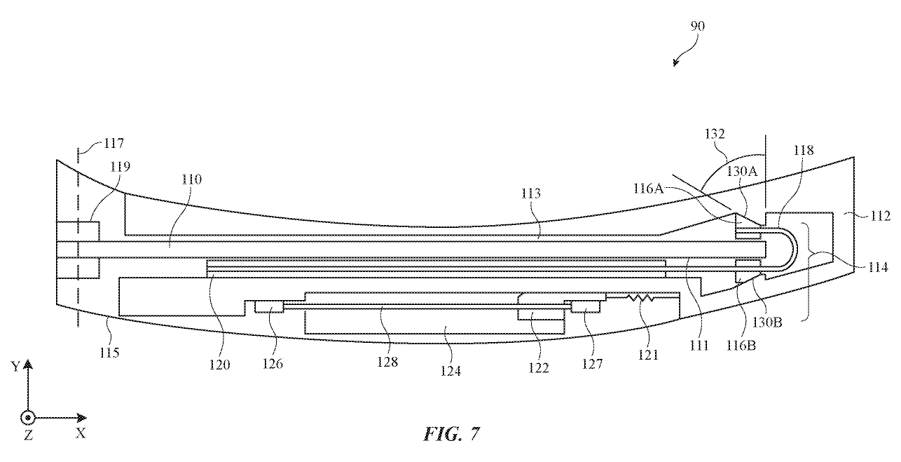

FIG. 7 is a cross-sectional side view of an illustrative actuator 90 that may be used to adjust a tunable lens element. Actuator 90 may include structure 110 (sometimes referred to as rotating structure 110, movable structure 110, or main structure 110 herein) and brake assembly 114. Structure 110 may be moved by actuating component 119 that is coupled to structure 110, such as one or more shape memory alloy (SMA) wires, motors, magnets, hydraulic actuators, and/or any other suitable actuators. For example, SMA wires may run from one end of structure 110 to another end of structure 110 and may be expanded/contracted to rotate structure 110 about pivot axis 117. However, this is merely illustrative. In general, any suitable actuating component may be coupled to structure 110 and may be used to move structure 110. For example, structure 110 may be rotated about pivot axis 117 by actuating component 119. In the illustrative example of FIG. 7, structure 110 may move into and out of the page (e.g., by being rotated by actuating component 119) in the +Z and -Z directions. Structure 110 may be coupled to a portion of lens shaping element 88 of FIG. 6, such as extension 88E. Therefore, by moving structure 110 using an actuator, lens shaping element 88 may be adjusted.

Structure 110, the associated actuator(s), and brake assembly 114 may be formed in actuator housing 112 (also referred to as housing 112 herein). Actuator housing 112 may be formed from polymer, metal, or another suitable material.

When structure 110 (and therefore lens shaping element 88) is not being adjusted, it may be desirable to fix the position of structure 110 using brake assembly 114. Brake assembly 114 may include one or more brakes. In the example of FIG. 7, brake assembly 114 includes two brakes: brake caliper 116A (also referred to as caliper 116A herein) and brake caliper 116B (also referred to as caliper 116B herein). Brake caliper 116A may apply a first force (e.g., in the -Y direction) to surface 113 of main structure 110, and brake caliper 116B may apply a second force (e.g., in the +Y direction) to surface 111 of main structure 110.

Brake calipers 116 may be attached to one another using component 118. Component 118 may have a curved shape and may be formed from an insert molded component, a metal component that is bent into a curved shape, or another suitable component. Each of brake calipers 116 may have a wedge-shaped surface. For example, brake caliper 116A may have wedge-shaped surface 130A and brake caliper 116B may have wedge-shaped surface 130B. Housing 112 may have wedges that engage the wedge-shaped surfaces 130 of brake calipers 116.

The wedges of housing 112 (that engage wedge-shaped surfaces 130) may extend at angle 132 relative to the Y-axis. Angle 132 may be selected based on a desired/suitable gearing between the force of spring mechanism 124 and the force of brake calipers 116 on structure 110. For example, if the wedge angle is increased, then the gearing between the force of spring mechanism 124 and the force of brake calipers 116 on structure 110 is increased. Therefore, angles of wedges of housing 112 may be adjusted to adjust the force applied to structure 110 using brake calipers 116.

Component 118 may be coupled to portion 120, which in turn may be coupled to spring mechanism 124. Spring mechanism 124 may include shuttle 122. Shuttle 122 may be biased in the position shown in FIG. 7 using a spring or another suitable biasing mechanism, such as spring 121 that extends between shuttle 122 and housing 112 (or another fixed structure).

Shuttle 122 may be coupled to one or more spring actuation components, such as one or more SMA wires, one or more motors, one or more magnets, and/or one or more hydraulic components. In the example of FIG. 7, shuttle 122 may be coupled to SMA wire 128 via anchor 127. Anchor 126 of SMA wire 128 may be coupled to a portion of actuator 90 outside of spring mechanism 124, such as to a portion of housing 112.

Anchors 126 and 127 may sometimes be referred to as connectors 126 and 127, mechanical connectors 126 and 127, electrical connectors 126 and 127, and mechanical and electrical connectors 126 and 127 herein. In particular, anchors 126 and 127 may be both mechanically and electrically connected to SMA wire 128. Mechanically, anchor 126 may be attached to housing 112 (or another suitable fixed structure) and anchor 127 may be coupled to shuttle 122. Anchors 126 and 127 may also provide electrical connections to SMA wire 128. Control circuitry 14 (FIG. 1) may control voltages applied to anchors 126 and 127 to control a current through SMA wire 128. The current through SMA wire 128 may be adjusted to selectively contract SMA wire 128.

In operation, because shuttle 122 is maintained in the position of FIG. 7 by a biasing member, such as spring 121, brake calipers 116 may engage structure 110 in a resting state. In this way, brake calipers 116 may prevent structure 110 from moving and adjusting the associated lens.

When it is desired to adjust the lens, SMA wire 128 may be contracted (e.g., by adjusting the current through SMA wire 128), which may move shuttle 122 (and therefore portion 120 to which shuttle 122 is coupled) in the -X direction. Component 118 may similarly be moved in the -X direction, which may move brake calipers 116 away from main structure 110 along the wedges of housing 112. When brake calipers 116 are disengaged/moved away from main structure 110, the one or more actuators (e.g., additional SMA wires or motors) may be used to move main structure 110 and adjust the lens.

After adjustment, SMA wire 128 may be extended to its original position (e.g., the position shown in FIG. 7), and the biasing mechanism (e.g., a spring) may move shuttle 122, portion 120, and component 118, in the +X direction. Therefore, brake calipers 116 may move along the wedges of housing 112 toward and into contact with structure 110. In other words, brake calipers 116 may engage structure 110 to prevent further movement of structure 110 and adjustment of the lens. In this way, brake calipers 116 may apply a force to structure 110 to selectively fix a position of structure 110.

In particular, brake calipers 116 may apply the force to structure 110 in a direction parallel to the pivot axis of structure 110. In the example of FIG. 7, structure 110 is configured to rotate in the +Z and -Z directions, placing the pivot axis along the Y-axis. By using brake calipers 116 to apply the force to structure 110 parallel to the Y-axis (e.g., in the +Y and -Y directions), the position structure 110 may be fixed without applying undue stress to structure 110.

Brake assembly 114, main structure 110, and actuator 119 may all fit within actuator housing 112. In particular, actuator housing 112 may have outer surface 115, with a radius of curvature of 30 mm or less, of 25 mm or less, of between 20 mm and 30 mm, or another suitable radius of curvature.

Although shuttle 122 is shown as being actuated by SMA wire 128, this is merely illustrative. In general, spring mechanism 124 may include any suitable actuator(s), such as motors.

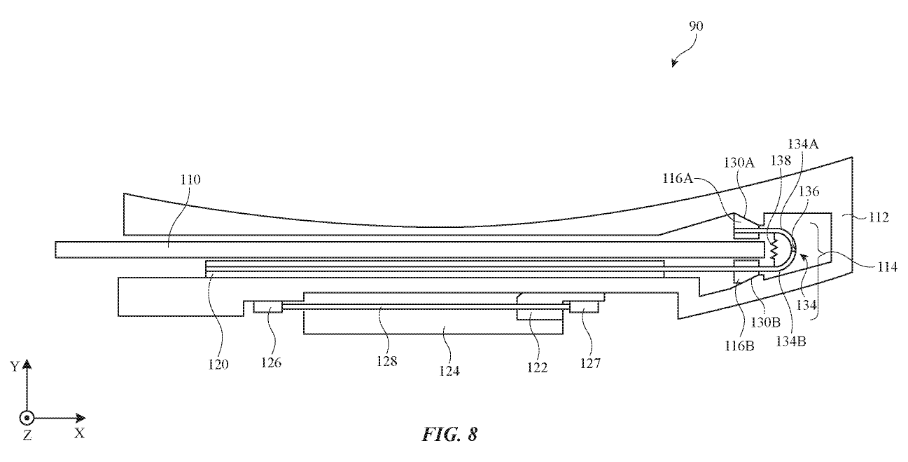

The example of FIG. 7 in which an insert molded component is used for component 118, is merely illustrative. In some embodiments, other components may be used to close brake calipers 116. An illustrative example of a flexible component that pivots to close brake calipers 116 is shown in FIG. 8.

As shown in FIG. 8, brake calipers 116A and 116B may be coupled using component 134 of brake assembly 114. Component 134 may include portions 134A and 134B that are joined at pivot 136. Pivot 136 may be a fastener, such as a pin, that attaches portions 134A and 134B together.

Portions 134A and 134B may expand and contract relative to one another about pivot 136. Additionally, a biasing member, such as expansion spring 138, may extend between portions 134A and 134B to bias portions 134A and 134B away from one another.

In operation, when SMA wire 128 (or other actuator) pulls shuttle 122 and portion 120 in the -X direction, component 134 may move in the -X direction, and portions 134A and 134B may be pushed away from each other (e.g., by expansion spring 138). Therefore, brake calipers 116 may be moved along the wedges of housing 12 away from structure 110.

Instead of, or in addition to, using SMA wire or another actuator in spring mechanism 124 to move component 134, a piezoelectric element may be incorporated between calipers 116 and pivot 136. The piezoelectric element may push portions 134A and 134B away from each other when it is desired to disengage brake calipers 116 from structure 110. In these embodiments, spring mechanism 124 (including SMA wire 128) may be omitted from actuator 90, if desired.

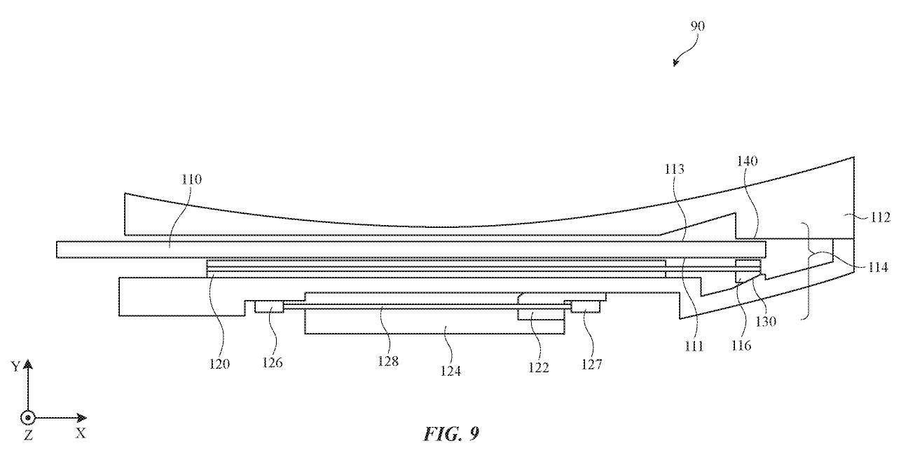

In some embodiments, instead of having brake calipers 116 on both sides of structure 110, a single brake caliper may apply a force to a single surface of structure 110. An illustrative example is shown in FIG. 9.

As shown in FIG. 9, brake assembly 114 may include a single caliper 116. In operation, caliper 116 may be pulled in the -X direction along a wedge of housing 112 by portion 120 (and shuttle 122) in response to contraction by SMA wire 128 (or the actuation of another actuator) to disengage structure 110.

When caliper 116 is engaging structure 110, caliper 116 may apply a force against surface 111 of structure 110. Surface 113 may be pushed against a portion of housing 112, such as portion 140, or against another suitable fixed structure (such as a pad affixed to housing 112). In this way, a single caliper may fix the position of structure 110.

Regardless of whether one or two calipers 116 are used in brake assembly 114, the wedge-shaped surfaces of caliper(s) 116 and/or the wedge(s) of housing 112 may be coated to reduce friction when caliper(s) 116 move along the wedge(s) of housing 112. Alternatively or additionally, ball bearings or other suitable friction-reducing components may be included between caliper(s) 116 and the wedge(s) of housing 112.

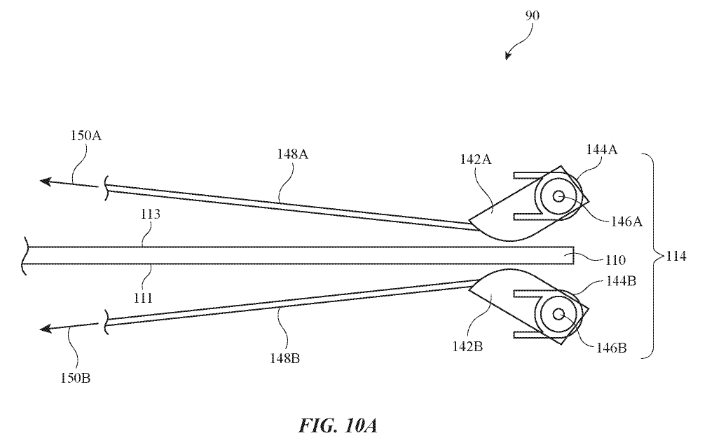

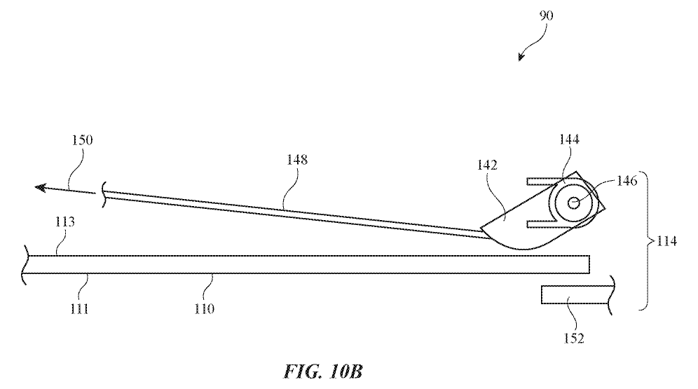

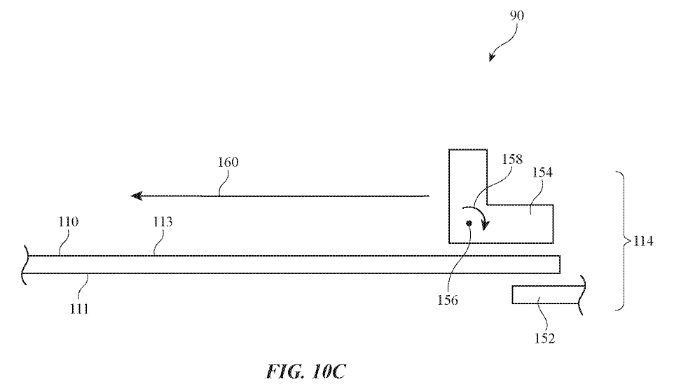

Although FIGS. 7-9 have shown brake assembly 114 including brake calipers 116 having wedge-shaped surfaces that move along a wedge of a housing, this is merely illustrative. In general, brake assembly 114 may include any suitable brakes. For example, in some embodiments, brake assembly 114 may include brake calipers with wedge-shaped surfaces that slope in the opposite direction as shown in FIGS. 7-9, and housing 112 may have wedges with matching slope. In other embodiments, brake assembly 114 may include brake cams and/or other brake structures. Illustrative examples are shown in FIGS. 10A-10C.

As shown in FIG. 10A, brake assembly 114 of actuator 90 may include brake cams 142A and 142B (also referred to as cams 142A and 142B herein). Cam 142A may be biased against surface 113 of structure 110 by rotary spring 144A, and cam 142B may be biased against surface 111 of structure 110 by rotary spring 144B. To release cams 142A and 142B from structure 110, an actuator may be used to rotate cams 142A and 142B about pivots 146A and 146B, respectively. In the illustrative example of FIG. 10A, SMA wire 148A may be contracted to pull cam 142A in direction 150A, and SMA wire 148B may be contracted to pull cam 142B in direction 150B. In this way, cams 142 may be disengaged from structure 110, allowing structure 110 to be moved.

When structure 110 has been adjusted, SMA wires 148 may be expanded, and rotary springs 144 may place cams 142 back into contact with structure 110.

Instead of using two brake cams in brake assembly 114, a single brake cam may be used. An illustrative example is shown in FIG. 10B.

As shown in FIG. 10B, brake assembly 114 may include a single cam 142. Single cam 142 may apply a force to surface 113 (or surface 111) of structure 110, and the opposite surface (surface 111 in the example of FIG. 10B) may be pushed into contact with fixed member 152. Fixed member 152 may be, for example, a portion of actuator housing 112 (FIGS. 7-9). In this way, a single cam 142 may be used to maintain the position of structure of 110.

The cam structures of FIGS. 10A and 10B are merely illustrative of brakes that may be used to fix the position of structure 110. In some embodiments, one or more L-shaped brake structures may be used. An illustrative example is shown in FIG. 10C.

As shown in FIG. 10C, brake assembly 114 may include L-shaped brake structure 154 that is biased (e.g., by a rotary spring or other biasing component) in direction 158 about pivot 156. Therefore, L-shaped brake structure 154 will apply a force to surface 113 (or surface 111) of structure 110, and the opposite surface (surface 111 in the example of FIG. 10C) may be pushed into contact with fixed member 152. In this way, L-shaped structure brake 154 may form a brake in brake assembly 114 to fix a position of structure 110. When it is desired to adjust structure 110, L-shaped brake structure 154 may be pulled in direction 160 (e.g., using an SMA wire) to disengage L-shaped brake structure 154 from structure 110.

Although FIG. 10C has shown brake assembly 114 including a single L-shaped brake structure 154 applying a force to one of the surfaces of structure 110, this is merely illustrative. Brake assembly 114 may include multiple L-shaped brake structures 154, such as L-shaped brake structures 154 to apply forces to both sides of structure 110, if desired.

Although FIGS. 10A-10C have shown and described adjusting brake cams and/or L-shaped structures using one or more SMA wires, this is merely illustrative. In general, any suitable actuator, such as motors, hydraulic actuators, or magnetic actuators, as examples, may be used to adjust brake cams and/or L-shaped structures in brake assembly 114.

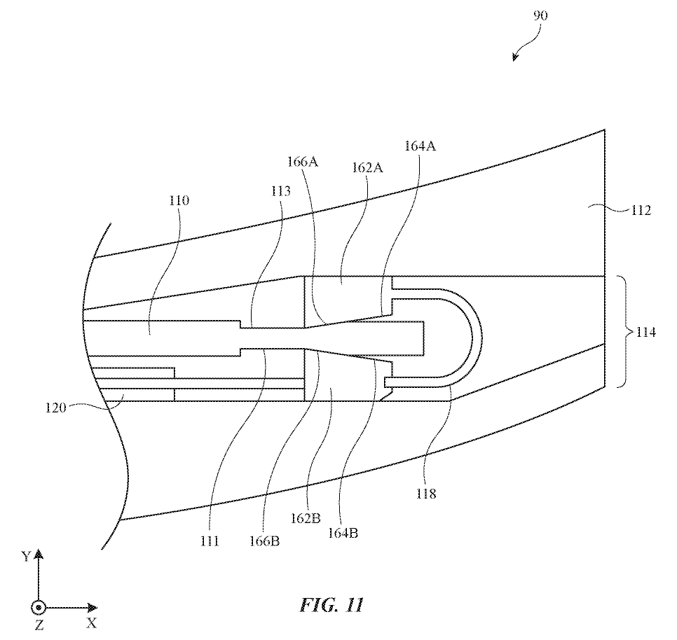

In the examples of FIGS. 7-9, housing 112 is shown as having wedges, and calipers 116 are shown as having wedge-shaped surfaces that move along the wedges of the housing. However, this arrangement is merely illustrative. In some embodiments, brake assembly 114 may include brake calipers with wedge-shaped surfaces that engage with wedges of structure 110. An illustrative example is shown in FIG. 11.

As shown in FIG. 11, structure 110 may include wedge 166A on surface 113 and wedge 166B on surface 111. Brake caliper 162A may have wedge-shaped surface 164A that engages with wedge 166A, and brake caliper 162B may have wedge-shaped surface 164B that engages with wedge 166B. In this way, brake calipers 162 may move along wedges 166 to engage structure 110 and fix the position of structure 110. When it desired to adjust structure 110, brake calipers 162 may be moved in the -X direction, away from wedges 166.

In the example of FIG. 11, brake calipers 162 may move not move along housing 112, instead being guided into contact with structure 110 by wedges 166 of structure 110.

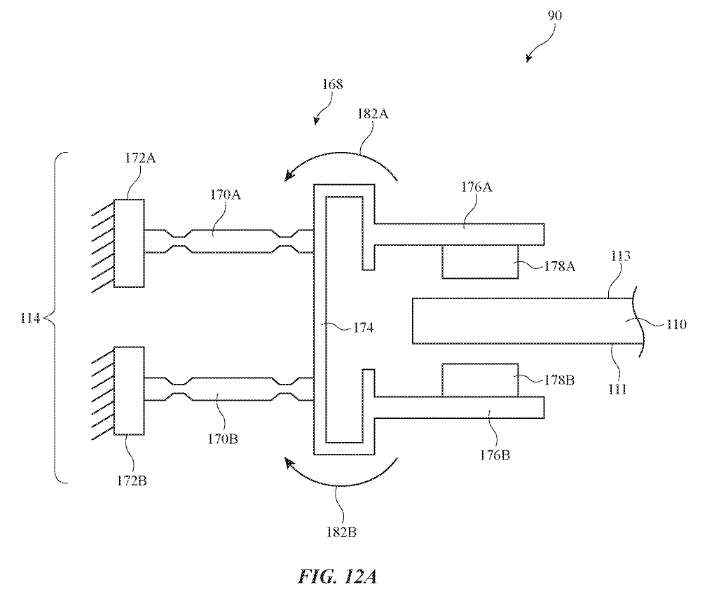

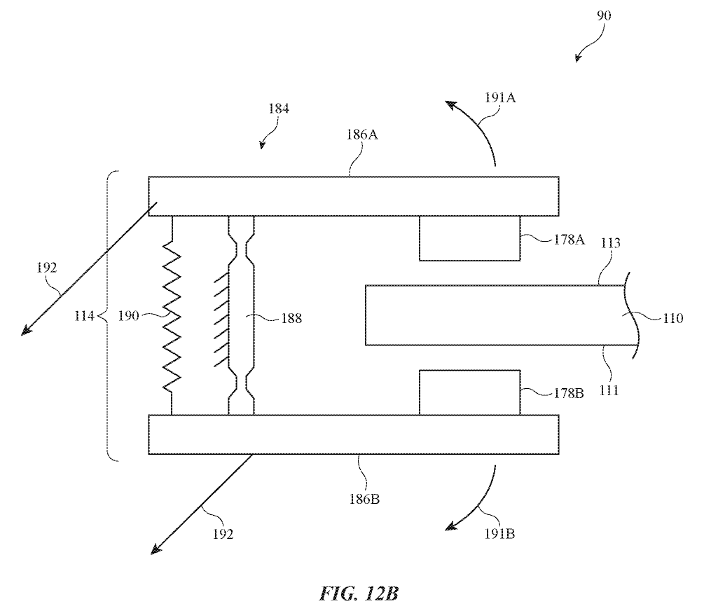

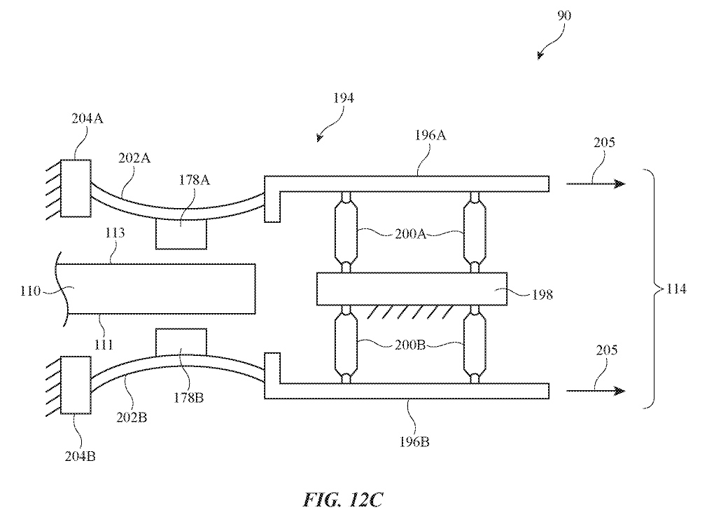

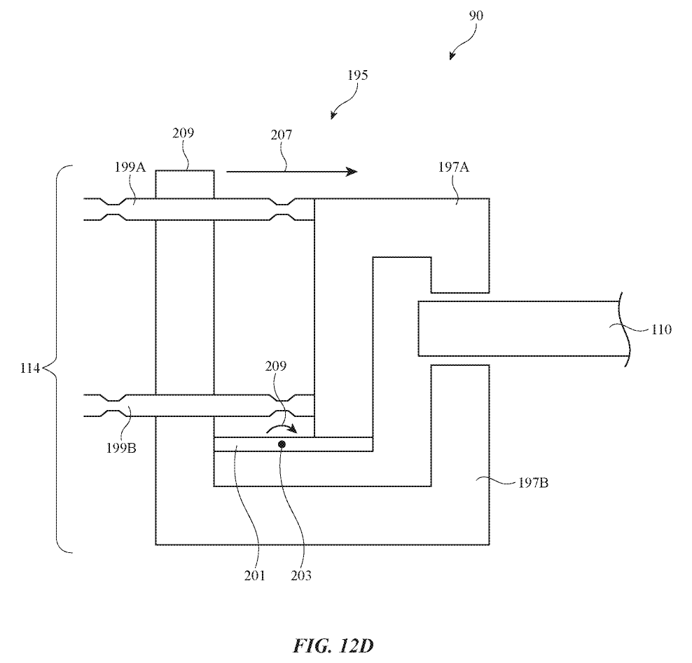

Instead of, or in addition to, using brake calipers (e.g., brake calipers 116 of FIGS. 7-9 or brake calipers 162 of FIG. 11), brake cams (e.g., cams 142 of FIGS. 10A and 10B), or L-shaped brakes (e.g., L-shaped brake structures 154 of FIG. 10C), flexures may support brakes and be used to move the brakes into and out of contact with structure 110. Illustrative examples of flexures that may be used are shown in FIGS. 12A-12D.

As shown in FIG. 12A, brake assembly 114 may include flexure 168. Flexure 168 may include flexure arms 170A and 170B that are respectively attached to fixed components 172A and 172B. Fixed components 172A and 172B may be, for example, a portion of actuator housing 112 or attached to housing 112 (FIGS. 7-9). Flexure arms 170A and 170B may be coupled to central flexure portion 174, which in turn may be attached to flexure brake pad carriers 176A and 176B. Brake pads 178A and 178B may be coupled to flexure brake pad carriers 176A and 176B, respectively.

Central flexure portion 174 may be at least partially flexible. For example, central flexure portion 174 may be able to bend/flex in directions 182A and 182B. In some embodiments, central flexure portion 174 may be formed from elastomeric material. However, this is merely illustrative. Central flexure portion 174 may be formed from any suitable flexible or partially flexible material.

In general, flexure 168 may bias brake pad 178A against surface 113 of structure 110 and brake pad 178B against surface 111 of structure 110, which may prevent movement of structure 110. When it is desired to adjust the position of structure 110, central flexure portion 174 may be bent in directions 182A and 182B. For example, central flexure portion 174 may be moved in directions 182A and 182B using one or more flexure actuation components such as one or more SMA wires (e.g., by contracting the SMA wires), one or more motors, one or more magnets, and/or one or more hydraulic actuators. The bending of central flexure portion 174 in directions 182A and 182B may move flexure brake pad carriers 176A and 176B and therefore brake pads 178A and 178B in directions 182A and 182B. In this way, brake pads 178 may be moved away/disengaged from structure 110, allowing structure 110 to be moved. Releasing central flexure portion 174 (e.g., by relaxing the SMA wires) will return brake pads 178 into contact with structure 110.

Another illustrative example of a flexure that may be used in brake assembly 114 is shown in FIG. 12B. As shown in FIG. 12B, flexure 184 may include flexure arms 186A and 186B coupled by bar 188. Bar 188 may be a stiff bar attached to a fixed portion (e.g., housing 112) while allowing flexure arms 186A and 186B rotate in directions 191A and 191B, respectively. Brake pads 178A and 178B may be coupled to flexure arms 186A and 186B, respectively.

Biasing component 190 (e.g., an expansion spring) may bias flexure arms 186A and 186B in the directions opposite directions 191A and 191B. Therefore, absent any external force, brake pad 178A may be biased against surface 113 of structure 110, and brake pad 178B may be biased against surface 111 of structure 110. In this way, structure 110 may be fixed in place by brake pads 178.

When it is desired to adjust structure 110, portions of flexure arms 186A and 186B may be moved in common direction 192. For example, the portions of flexure arms 186A and 186B may be moved in direction 192 using one or more flexure actuation components such as one or more SMA wires (e.g., by contracting the SMA wires), one or more motors, one or more magnets, and/or one or more hydraulic actuators. The movement of the portions of flexure arms 186A and 186B in common direction 192 may rotate flexure arms 186A and 186B about the flexible portions of bar 188 (e.g., in directions 191A and 191B, respectively). The rotation of flexure arms 186A and 186B may move brake pad 178A away from surface 113 in direction 191A and may move brake pad 178B away from surface 111 in direction 191B, which may allow structure 110 to be moved. Releasing flexure arms 186A and 186B (e.g., by relaxing the SMA wires) will return brake pads 178 into contact with structure 110.

Another illustrative example of a flexure that may be used in brake assembly 114 is shown in FIG. 12C. As shown in FIG. 12C, flexure 194 may include flexure arms 196A and 196B coupled by bar 198 and by flexures 200A and 200B. Bar 198 may be a stiff bar attached to a fixed portion (e.g., housing 112) while allowing flexure arms 196A and 196B to move in common direction 205. Brake pads 178A and 178B may be coupled to flexure brake pad carriers 202A and 202B, respectively. Flexure brake pad carrier 202A may be coupled between flexure arm 196A and fixed portion 204A (e.g., a portion of housing 112), and flexure brake pad carrier 202B may be coupled between flexure arm 196B and fixed portion 204B (e.g., a portion of housing 112).

Due to flexure brake pad carrier 202 being coupled between flexure arms 196 and fixed portions 204, brake pad 178A may be biased against surface 113 of structure 110, and brake pad 178B may be biased against surface 111 of structure 110. In this way, structure 110 may be fixed in place by brake pads 178.

When it is desired to adjust structure 110, flexure arms 196A and 196B may be moved in common direction 205. For example, flexure arms 196A and 196B may be moved using one or more flexure actuation components such as one or more SMA wires (e.g., by contracting the SMA wires), one or more motors, one or more magnets, and/or one or more hydraulic actuators. The movement of flexure arms 196A and 196B in common direction 205 may move flexure arms 196 in common direction 205, which may move flexure brake pad carrier 202A upward and flexure brake pad carrier 202B downward. This movement may move brake pad 178A away from surface 113 and brake pad 178B away from surface 111, allowing structure 110 to be moved. Releasing flexure arms 196A and 196B (e.g., by relaxing the SMA wires) will return brake pads 178 into contact with structure 110.

Another illustrative example of a flexure that may be used in brake assembly 114 is shown in FIG. 12D. As shown in FIG. 12D, flexure 195 may include brake calipers 197A and 197B. Brake caliper 197A may be coupled to flexures 199A and 199B, and brake caliper 197A may be coupled to brake caliper 197B via spring 201. Flexures 199A and 199B may be compliant flexures but may be stiff in a direction out of the page. Spring 201 may be a preloaded spring that is coupled to rotation point (e.g., pivot 203). Although two flexures 199A and 199Bare shown in the example of FIG. 12D, any suitable number of flexures, such as a single flexure, may be coupled to brake caliper 197A.

Due to brake caliper 197A being coupled to flexures 199A and 199B, and brake caliper 197B being coupled to brake caliper 197A, brake calipers 197A and 197B may be biased toward structure 110. Therefore, in the absence of force on flexure 195, structure 110 may be fixed in place by brake calipers 197.

When it is desired to adjust structure 110, an upper portion of brake caliper 197B (e.g., near surface 209) may be moved in direction 207. For example, the upper portion of brake caliper 197B may be moved using one or more flexure actuation components such as one or more SMA wires (e.g., by contracting the SMA wires), one or more motors, one or more magnets, and/or one or more hydraulic actuators. The movement of the upper portion of brake caliper 197B in direction 207 may rotate the bottom portion of brake caliper 197B away from structure 110 and may disengage brake caliper 197B from structure 110. At the same time, the movement of the upper portion of brake caliper 197B in direction 207 may rotate spring 201 about pivot 203 in direction 209, thereby moving brake caliper 197A away from structure 110. Therefore, the movement of the upper portion of brake caliper 197B in direction 207 may move brake calipers 197 away from structure 110, allowing structure 110 to be moved. Releasing the upper portion of brake caliper 197B (e.g., by relaxing the SMA wires) will return brake calipers 197 into contact with structure 110.

Although not shown in FIG. 12D, brake pads may be coupled between brake calipers 197 and structure 110, if desired. Moreover, although the illustrative example of FIG. 12D shows rotation being provided by flexure 195, brake calipers 197 may instead by rotated by a sliding or rolling bearing instead of a flexure, and the spring (e.g., spring 201) may be provided by an external component (e.g., a component outside of brake assembly 114).

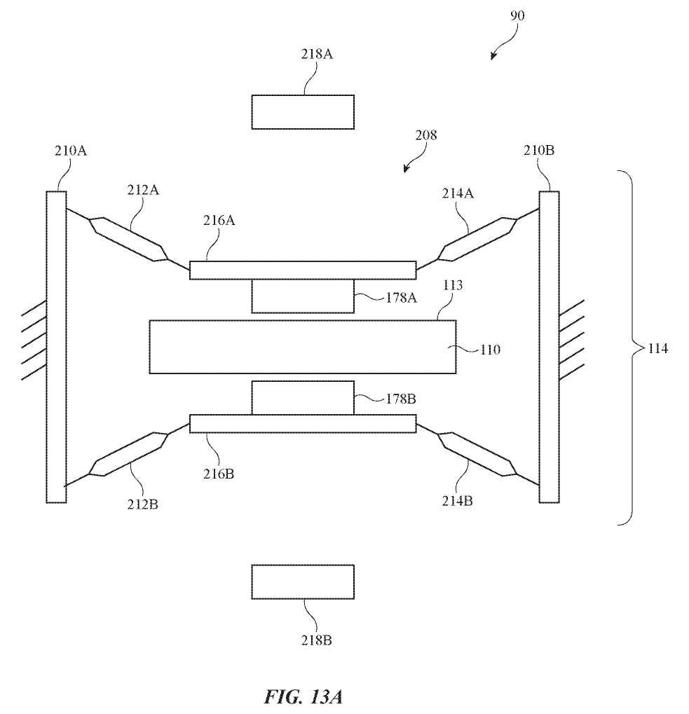

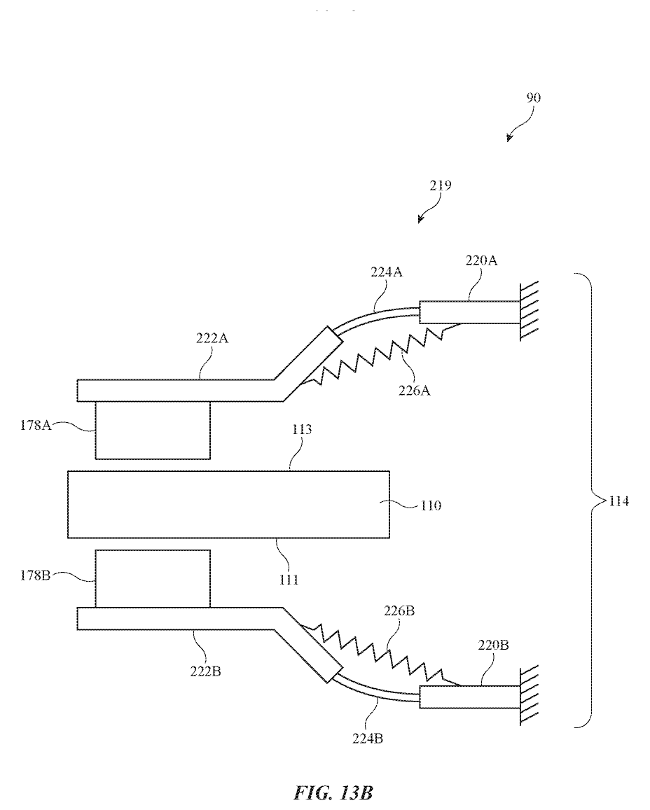

In the examples of FIGS. 12A-12D, the flexures are biased for the brake pads to engage structure 110 unless one or more forces are being applied to the flexures. In other words, the brake pads are biased toward structure 110. However, in some embodiments, it may be desirable for the brake pads to be stable when engaging structure 110 and when disengaged from structure 110. Therefore, bistable flexures may be used in brake assembly 114. Illustrative examples of bistable flexures are shown in FIGS. 13A and 13B.

As shown in FIG. 13A, brake assembly 114 may include bistable flexure 208. Bistable flexure 208 may include fixed portions 210A and 210B (e.g., portions of housing 112). Flexure arms 212A and 212B may be coupled to fixed portion 210A, and flexure arms 214A and 214B may be coupled to fixed portion 210B. Flexure arm 216A may be coupled between flexure arms 212A and 214A, and flexure arm 216B may be coupled between flexure arms 212B and 214B. Brake pad 178A may be coupled to flexure arm 216A, and brake pad 178B may be coupled to flexure arm 216B.

In operation, flexure 208 may be stable in a first state with brake pad 178A applying a force against surface 113 of structure 110 and brake pad 178B applying a force against surface 111 of structure 110. When it is desired to move brake pads 178 away from structure 110, flexure actuation components 218 (e.g., magnets) may be activated to move flexure arms 212, 214, and 216, and therefore brake pads 178, away from structure 110. When flexure arms 212, 214, and 216, and brake pads 178 have been moved away from structure 110, flexure 208 may be in a second state. Flexure 208 may be stable in both the first state in the second state. In other words, flexure actuation components 218 may need to be activated again (e.g., with an opposite polarity) to move flexure 208 back to the first state after it has been moved into the second state. In this way, flexure 208 may be a bistable flexure that may be used to move brake pads 178 into and out of contact with structure 110.

Another illustrative bistable flexure is shown in FIG. 13B. As shown in FIG. 13B, brake assembly 114 may include bistable flexure 219. Bistable flexure 219 may include fixed portions 220A and 220B (e.g., portions of housing 112). Flexure arm 222A may be coupled to fixed portion 220A via flexible portion 224A and spring 226A, and flexure arm 222B may be coupled to fixed portion 220B via flexible portion 224B and spring 226B. Brake pad 178A may be coupled to flexure arm 222A, and brake pad 178B may be coupled to flexure arm 222B.

In operation, flexure 219 may be stable in a first state with brake pad 178A applying a force against surface 113 of structure 110 and brake pad 178B applying a force against surface 111 of structure 110. When it is desired to move brake pads 178 away from structure 110, flexure actuation components (e.g., SMA wires, magnets, motors, etc.) may be activated to move flexure arms 222, and therefore brake pads 178, away from structure 110. When flexure arms 222 and brake pads 178 have been moved away from structure 110, flexure 219 may be in a second state. Due to the presence of springs 226A and 226B, flexure 219 may be stable in both the first state in the second state. In other words, the flexure actuation components (e.g., SMA wires, magnets, motors, etc.) to move flexure 219 back to the first state after it has been moved into the second state. In this way, flexure 219 may be a bistable flexure that may be used to move brake pads 178 into and out of contact with structure 110.

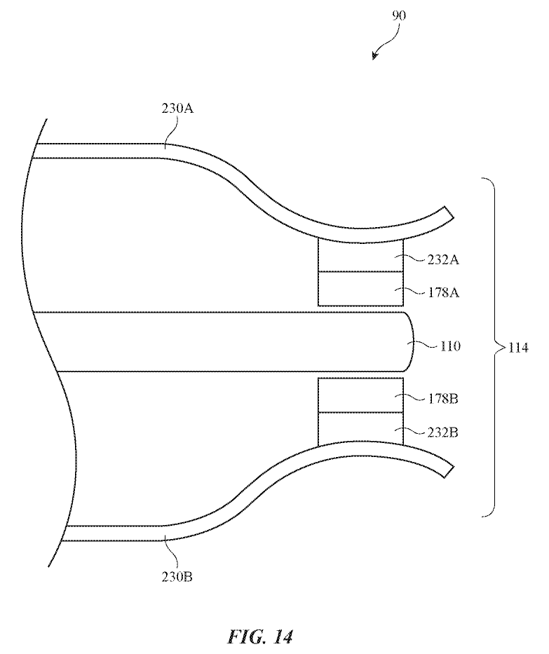

In some embodiments, flexure springs may be coupled to piezoelectric elements to support brakes and to move the brakes into and out of contact with structure 110. An illustrative example is shown in FIG. 14.

As shown in FIG. 14, brake assembly 114 may include flexure springs 230A and 230B. Flexure springs 230A and 230B may be, for example, pre-formed flexure springs formed from metal, polymer, and/or other suitable material(s). In some embodiments, flexure springs 230A and 230B may be parallel arms (e.g., parallel flexure spring arms) of a single flexure spring (e.g., a pre-formed flexure spring). In other words, flexure springs 230A and 230B may be flexure spring arms 230A and 230B. However, this is merely illustrative. In general, one or more spring structures may be used to form flexure springs 230A and 230B. For example, flexure springs 230A and 230B may be formed from coil springs.

Flexure springs 230A and 230B may be grounded mechanically within brake assembly 114, or may be assembled in structure (e.g., flexure springs 230A and 230B may be separately attached to one another and/or to other portions of brake assembly 114).

Piezoelectric member 232A may be coupled to flexure spring 230A, and brake pad 178A may be coupled to piezoelectric member 232A. Similarly, piezoelectric member 232B may be coupled to flexure spring 230B, and brake pad 178B may be coupled to piezoelectric member 232B.

Piezoelectric members 232 may each include one or more multi-layer piezoelectric elements (e.g., stacked piezoelectric elements), or may include one or more single layer piezoelectric elements. Piezoelectric members 232 may be electrically coupled to circuitry in the electronic device, such as control circuitry 14 (FIG. 1) using flexure springs 230A and 230B (e.g., if flexure springs 230A and 230B are formed from conductive material) and/or other suitable electrical connectors.

Overall, brake assembly 114 may be stiff in the arrangement of FIG. 14. In particular, flexure springs 230, piezoelectric members 232, and brake pads 178 may combine to have a high resonant quality factor.

In operation, flexure springs 230 may bias piezoelectric members 232 and brake pads 178 toward structure 110. Piezoelectric members 232 may vibrate brake pads 178, pushing brake pads 178 against the upper and lower surfaces of structure 110 with a periodic normal force. In particular, piezoelectric members 232 may be adjusted between applying a high normal force against the surfaces of structure 110 and applying a low normal force against the surfaces of structure 110 (e.g., by adjusting the voltage on piezoelectric members 232). When piezoelectric members 232 apply the high normal force, the friction between brake pads 178 and structure 110 may be sufficient to prevent structure 110 from moving. When piezoelectric members apply the low normal force, the friction between brake pads 178 and structure 110 may be low enough to allow structure 110 to be adjusted. In this way, flexure springs 230, piezoelectric members 232, and brake pads 178 may apply an adjustable periodic normal force to structure 110 to brake structure 110.

The examples of FIGS. 7-14 where actuator 90 is configured to move structure 110 Z-direction about a Y-axis pivot axis and where brake assembly 114 is configured to apply brake force(s) in a direction parallel to the Y-axis pivot axis is merely illustrative. In general, the actuators of FIGS. 7-14 may be used in any desired application and may move any desired component in any suitable direction. In other words, actuator 90 may be oriented in any suitable direction, and brake assembly 114 is configured to apply brake force(s) in a direction parallel to the pivot axis

The foregoing is merely illustrative, and various modifications can be made to the described embodiments. The foregoing embodiments may be implemented individually or in any combination.

What is claimed is:

1. An actuator comprising:
a main structure;
an actuating component that is coupled to the main structure and is configured to selectively rotate the main structure about a pivot axis; and
a brake assembly that is configured to selectively fix a position of the main structure, wherein the brake assembly comprises a brake that is configured to apply a force to the main structure in a direction parallel to the pivot axis.

2. The actuator of claim 1, wherein the actuating component comprises a shape memory alloy wire.

3. The actuator of claim 1, wherein the main structure has opposing first and second surfaces, the actuator further comprising:
a housing in which the main structure, the actuating component, and the brake assembly are formed, wherein the housing has a wedge, and the brake is a brake caliper that is configured to move along the wedge of the housing to apply the force to the first surface of the main structure.

4. The actuator of claim 3, wherein the brake assembly further comprises a spring that is configured to pull on the brake caliper to maintain the force of the brake caliper on the main structure and a spring actuation component configured to selectively engage the spring to move the brake caliper along the wedge and away from the main structure.

5. The actuator of claim 4, wherein the spring actuation component comprises a shape memory alloy wire.

6. The actuator of claim 4, wherein the brake caliper is configured to push the second surface of the main structure into contact with a portion of the housing.

7. The actuator of claim 4, wherein the housing comprises an additional wedge, the main structure is interposed between the wedge and the additional wedge, and the brake assembly further comprises an additional brake caliper that is configured to move along the additional wedge of the housing to apply an additional force to the second surface of the structure.

8. The actuator of claim 7, wherein the brake caliper and the additional brake caliper are coupled to the spring with an insert molded component.

9. The actuator of claim 7, wherein the brake caliper and the additional brake caliper are coupled to the spring using a component having first and second portions coupled at a pivot.

10. The actuator of claim 2, wherein the main structure comprises a wedge and the brake comprises a caliper with a wedge-shaped surface that is configured to engage with the wedge of the main structure to apply the force to the main structure.

11. The actuator of claim 2, wherein the brake comprises a brake cam that is configured to rotate to apply the force to the main structure.

12. The actuator of claim 11, wherein the brake cam is configured to apply the force to a first surface of the main structure, and the brake assembly further comprises an additional brake cam configured to apply an additional force to a second surface of the main structure opposite the first surface.

13. The actuator of claim 2, wherein the brake comprises an L-shaped brake structure that is configured to rotate to apply the force to the main structure.

14. The actuator of claim 2, wherein the brake is a first brake pad that applies the force to a first surface of the main structure, the brake assembly further comprises a second brake pad that applies an additional force to a second surface of the structure opposite the first surface, and the first and second brake pads are coupled to a flexure.

15. The actuator of claim 14, wherein the flexure comprises first and second flexure arms and a central flexure portion coupled to the first and second flexure arms, wherein the central flexure portion is configured to be bent to move the first and second brake pads away from the main structure.

16. The actuator of claim 14, wherein the flexure comprises first and second flexure arms, and wherein at least a portion of each of the first and second flexure arms are configured to be moved in a common direction to move the first and second brake pads away from the main structure.

17. The actuator of claim 14, wherein the flexure is a bistable flexure that is stable at a first position in which the first and second brake pads apply the force and the additional force to the main structure and a second position in which the brake pads are disengaged from the main structure.

18. The actuator of claim 17, wherein the brake assembly further comprises a magnet that is configured to move the flexure between the first position and the second position.

19. The actuator of claim 2, wherein the brake is a first brake caliper that applies the force to a first surface of the main structure, the brake assembly further comprises a second brake caliper that applies an additional force to a second surface of the structure opposite the first surface, the first brake caliper is coupled to at least one flexure, the first brake caliper is coupled to the second brake caliper with a spring coupled to a rotation point, and an upper portion of the second brake caliper is configured to be moved in a given direction to rotate the first and second brake calipers away from the first and second surfaces.

20. The actuator of claim 2, wherein the brake is a first brake pad that applies the force to a first surface of the main structure, the brake assembly further comprises a second brake pad that applies an additional force to a second surface of the structure opposite the first surface, the first and second brake pads are respectively coupled to first and second piezoelectric members which in turn are respectively coupled to first and second flexure springs, and the piezoelectric members are configured to vibrate to push the first and second brake pads against the main structure with an adjustable periodic normal force.

21. An actuator comprising:
a housing comprising first and second wedges;
a main structure in the housing, wherein the main structure comprises opposing first and second surfaces;
an actuating component in the housing that is configured to selectively rotate the main structure about a pivot axis; and
a brake assembly in the housing that is configured to selectively fix a position of the main structure, wherein the brake assembly comprises:
a first brake caliper that is configured to move along the first wedge of the housing to apply a first force to the first surface of the main structure in a first direction parallel to the pivot axis,
a second brake caliper that is configured to move along the second wedge of the housing to apply a second force to the second surface of the main structure in a second direction parallel to the pivot axis,
a spring that is configured to bias the first and second brake calipers toward the main structure to maintain the first and second forces on the main structure, and
a spring actuation component configured to selectively engage the spring to move the first and second brake calipers along the first and second wedges and away from the main structure.

22. An actuator comprising:
a housing;
a structure in the housing, wherein the structure comprises opposing first and second surfaces;
an actuating component in the housing is configured to selectively rotate the structure about a pivot axis; and
a brake assembly in the housing that is configured to selectively fix a position of the structure, wherein the brake assembly comprises:
a first brake pad that is configured to apply a first force to the first surface of the structure in a first direction parallel to the pivot axis,
a second brake pad that is configured to apply a second force to the second surface of the structure in a second direction parallel to the pivot axis,
a flexure to which the first and second brake pads are coupled, and
a flexure actuation component that is configured to move at least a portion of the flexure to move the first and second brake pads away from the structure.
